(19) United States
(12) Patent Application Publication
(10) Pub. No.: US 2007/0250319 A1
(43) Pub. Date: Oct. 25, 2007

(54) Song feature quantity computation device and song retrieval system

(75) Inventors: Masahiko Tateishi, Nagoya-city (JP); Fumihiko Murase, Pittsburgh, PA (US); Ichiro Akahori, Anjo-city (JP); Teruko Mitamura, Pittsburgh, PA (US)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/401,441

(22) Filed: Apr. 11, 2006

(51) Int. Cl. G10L 15/04

(52) U.S. Cl. 704/251

(57) ABSTRACT

Several feature phrases including combinations of words are predetermined to indicate a feature of a song. TF-IDF values are computed based on appearances counts of the feature phrases. A song feature quantity is computed as a vector constituted by the TF-IDF values. This vector is an index indicating the feature of the song. Using the feature phrases results in proper exclusion of a comment not related to the feature of the song itself in computing the song feature quantity. This allows the song feature quantity to match, with a high accuracy, with a mood generated when the song is actually listened to.

### FIELD OF THE INVENTION

The present invention relates to a song feature quantity computation device and a song retrieval system. The song feature quantity computation device computes a song feature quantity (or a quantity of a feature or characteristic of a song). The song feature quantity is associated with a song (song refers to a musical composition without or with words such as popular music or classical music) and stored in a song database. The song retrieval system retrieves a preferred song from the song database using a song feature quantity.

### BACKGROUND OF THE INVENTION

As described in Patent Document 1, a song database retrieval device is known to able to retrieve data of a preferred song from a song database using a mood expressional word instead of its song title or its artist name. The song database retrieval device includes a mood expression rule storage unit stores mood expression rules where mood expressional words such as “warm feeling” or “comfortable feeling” are specified. The mood expression rule storage unit stores (i) the above mood expressional words and (ii) their analysis results from several analysis items, both of which are associated with each other, to extract representative song data. The analysis items include, with respect to each song data, several analyses for (i) a frequency spectrum, (ii) a tempo or rhythm pattern, and (iii) a primary melody (or a theme).

Under this data structure, a user's input of a mood expressional word starts a retrieval by using its associated analysis result as reference data, and retrieves song data having a similar analysis result. Thus retrieved song data can be presented to the user.

However, a mood or impression from listening to or appreciating the retrieved song data may not match with the inputted mood expressional word even though the retrieved song data is associated with the inputted mood expressional word based on the analysis results using its frequency spectrum, tempo or rhythm pattern, and theme. That is, the impression from appreciating the song also depends on song words, singer's singing ways, etc., other than the analysis items. This indicates difficulty in accurately defining listener's impressions by simply using the above analysis items, posing a problem.

To deal with this problem, a song data player in Patent Document 2 is able to retrieve song data relatively matching with a user's selected mood. The song data player acquires artist names, album titles, genres, song features, song data file names, relevant URLs of websites, etc. to store them in a song information database. The data stored in the song information database are subjected to a morphological analysis to extract words such as nouns, adjectives, etc., and produce a word dictionary.

Each word included or registered in the word dictionary is assigned a word vector based on relation with predetermined feature words (e.g., from the first dimension to the fifth dimension, (i) human, (ii) ocean, (iii) music, (iv) heat, and (v) entertainment/hobby). For instance, a word “summer” has a word vector (0, 1, 0, 1, 0) based on a determination that “summer” is associated with feature words of “(ii) ocean” and “(iv) heat.”

For instance, suppose that “rock” having a vector (0, 0, 1, 0, 0) and “summer” having a vector (0, 1, 0, 1, 0) are registered in the word dictionary. Here, when a user inputs a certain word string “summer music by a rock band” in a song data retrieval, the word vectors of “rock” and “summer” are added together. A certain vector (0, 1, 1, 1, 0) can be thereby obtained for the certain word string. Song data having a vector similar to the certain vector is then retrieved by searching the song information database using the certain vector of the certain word string.

Thus, the song data player in Patent Document 2 assigns a word vector in units of words to each song data included in the song information database, by using feature words. However, all words included in certain song data stored in the song information database do not always indicate a feature of the certain song data, for instance, from the following reason.

Input of “song features” to a song information database is time-consuming for a user, so the “song features” may be acquired from reviews written by music specialists such as songwriters, or music companies or by individuals having listened to relevant songs. In this case, the reviews may include, in addition to a “song features” that is a feature of the relevant song itself, comments on singers or players, etc. This may result in possible computation of a vector of song information affected by the comment on singers or players in addition to the “song feature,” thereby posing a problem not properly retrieving a user's preferred song.
Patent Document 1: JP-2001-306580 A
Patent Document 2: JP-2003-84783 A

### SUMMARY OF THE INVENTION

It is a first object of the present invention to provide a song feature quantity computation device capable of computing a song feature quantity corresponding to a song feature itself (or a feature of each song itself) by using reviews that further include information other than the song feature. It is a second object to provide a song retrieval system capable of accurately retrieving a preferred song from a song database including song feature quantities.

To achieve the first object, a song feature quantity computation device is provided with the following: A song feature quantity is computed that is associated with a song of a plurality of songs and stored in a song database; an input unit is included for inputting a review data item including a review of the song; a feature phrase appearances count unit is included for computing, as an index indicating a feature of the song, a feature phase appearances count of each of a plurality of feature phrases in the inputted review data item, wherein each feature phrase is predetermined to include a combination of words; and a song feature quantity computation unit is included for computing values depending on the feature phrase appearances counts of the plurality of feature phrases, respectively, and computing a song feature quantity being a vector quantity constituted by the computed values as elements.

The review of a song in the review data item includes impressions from elements such as a tempo or rhythm, and from other elements such as words (or lyrics) or singing way of a singer. The review data items are abundantly available via the Internet or from music sales companies: using the available review data items dispenses with works to prepare new data. Here, the review data sometimes include comments not related to the feature of the song itself: computing a feature quantity characterizing the song feature simply based on the comments included in the review data has a possibility to not match with the actual feature of the song.

To decrease the above possibility, in the above song feature quantity computation device, several feature phrases are predetermined to indicate a feature of a song by including a combination of words; values are computed based on an appearances count of each feature phrase in the review data; a song feature quantity is computed as a vector quantity constituted by the values as elements; and the song feature quantity is regarded as an index indicating the feature of the song.

Thus, use of the feature phrase including the combination of words excludes as much as possible a possible comment not related to the feature of the song itself and thereby allows computation of the song feature quantity with a high accuracy. For instance, suppose that review data includes “song is cool” and “the face of a singer is cool,” both of which include “cool” on a word basis. Here, predetermining a feature phrase including a combination of “cool” and “song” enables a combination of “cool” and “the face of a singer” to be excluded from the feature phrase. Thus, computing an appearances count of the feature phrase can be performed with respect to the description part of the feature of the song itself. Using the feature phase achieves filtering for excluding comments not related to the feature of the song. Consequently, the song feature quantity computed based on the appearances count of the feature phrase can be accurately matched with a mood experienced when the song is actually listened to.

To achieve the second object, a song retrieval system is provided with the following: A song can be retrieved from the song database including song feature quantities computed by the song feature quantity computation device described above; a first retrieval specifying unit is included for specifying, as a song retrieval condition, a musical mood of a plurality of musical moods, wherein each of the musical moods is indicated by a mood expressional word; a corresponding range storage unit is included for storing a predetermined corresponding range of a song feature quantity relative to the specified musical mood; and a first retrieval unit is included for retrieving from the song database a song including a song feature quantity belonging to the specified musical mood, based on the corresponding range relative to the specified musical mood.

According to the above song retrieval system, a corresponding range of a song feature quantity is predetermined with respect to each musical mood indicated by a mood expressional word; and the corresponding range is stored while being associated with the musical mood. Therefore, specifying a musical mood as a retrieval condition can achieve retrieving a song matching with the specified musical mood based on whether the song to be retrieved has a feature quantity corresponding to the specified musical mood.

Here, to predetermine the corresponding range relative to each musical mood, for instance, several subject persons are requested to listen to a certain song to select one of several predetermined musical moods assumed to belong to the certain song. The resultant musical mood that has been most frequently selected by the subject persons is determined to be a musical mood of the certain song. Subsequently, another song of the several songs is listened to by the subject persons; thereby, each song is classified into one of the musical moods. Here, songs are selected so that at least one song is classified into each of the several musical moods. Based on the resultant correspondence relationship between each song and each musical mood, a corresponding range can be determined for a song feature quantity relative to each musical mood.

To achieve the second object, another song retrieval system is provided with the following: A song can be retrieved from the song database including song feature quantities computed by the song feature quantity computation device described above; a second retrieval specifying unit is included for specifying as a song retrieval condition a song stored in the song database and requiring a retrieval of a similar song that is similar to the specified song; and a second retrieval unit is included for retrieving the similar song, by defining the similar song and extracting the similar song from retrieval target songs that are the songs stored in the song database, based on a vector distance between (i) a song feature quantity of the specified song and (ii) each of song feature quantities of the retrieval target songs.

Under this structure, a similarity degree of another song relative to the specified song can be determined based on a vector distance computed from the respective song feature quantities; therefore, specifying a song within the song database enables retrieving a similar song with a high accuracy based on the respective song feature quantities.

To achieve the second object, yet another song retrieval system is provided with the following: A song can be retrieved from the song database including song feature quantities computed by the song feature quantity computation device described above; a third retrieval specifying unit is included for specifying, as a song retrieval condition, a retrieval sentence representing a feature of a song; a word count unit is included for determining whether a retrieval word corresponding to a word in a feature phrase is included in the specified retrieval sentence, and computing a word appearances count indicating how many times the retrieval word, which is determined to be included in the specified retrieval sentence, appears in the specified retrieval sentence; a retrieval feature quantity computation unit is included for computing a retrieval feature quantity being a vector quantity constituted by feature phrase appearances counts of the feature phrases by regarding the computed word appearances count of the retrieval word as a feature phrase appearances count of each of the feature phrases that includes the retrieval word; and a third retrieval unit is included for retrieving a certain song having a song feature quantity similar to the computed retrieval feature quantity, by defining the certain song from retrieval target songs that are the songs stored in the song database, based on a vector distance between (i) the computed retrieval feature quantity and (ii) each of song feature quantities of the retrieval target songs.

Under this structure, a vector distance between (i) the retrieval feature quantity and (ii) the song feature quantity of each song can be computed: the vector distance is an index showing a similarity between the retrieval sentence and the feature of the song. Thus, based on the vector distance, a song having the feature corresponding to the retrieval sentence can be retrieved.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing a schematic structure of a song feature quantity computation device according to a first embodiment of the present invention;

FIG. 2 is an explanatory diagram showing a determination method of feature phrase groups;

FIG. 3 is an explanatory diagram showing a computation method of a song feature quantity;

FIG. 4 is a block diagram showing a schematic structure of a song retrieval system according to the first embodiment;

FIG. 5 is a diagram showing a data structure of a song database;

FIG. 6 is a diagram showing a mood feature database;

FIG. 7 is a diagram showing an example of a song feature quantity range belonging to individual moods;

FIG. 8 is a block diagram showing a schematic structure of a song retrieval system according to a second embodiment;

FIG. 9 is a block diagram showing a schematic structure of a song retrieval system according to a third embodiment; and

FIGS. 10A to 10C are Japanese examples of relationships between main word groups and attribute word groups.

### DETAILED DESCRIPTION OF THE PREFERRED EMBODIMENTS

### First Embodiment

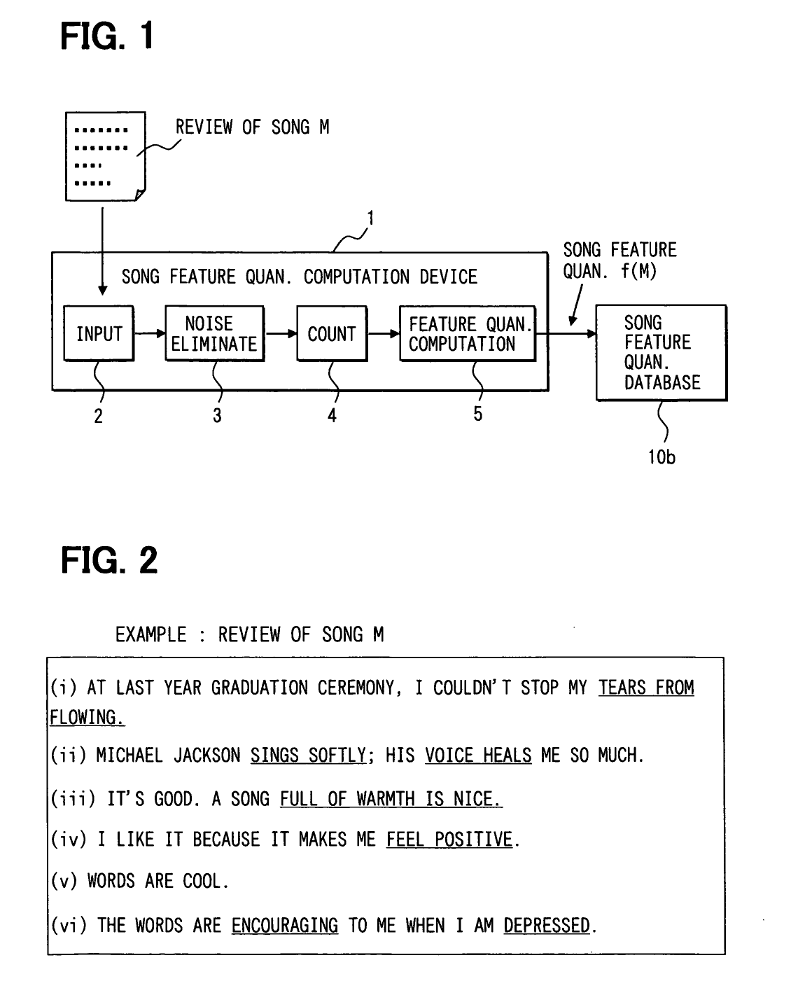

A first embodiment of the present invention will be explained with reference to FIGS. 1 to 7.

At first, a song feature quantity computation device 1 will be explained below. The device 1 is to compute a song feature quantity that is stored together with song title data (or song title data items) and song data (or song data items) in a song database. As shown in FIG. 1, the device 1 includes an input unit 2, a noise eliminating unit (or noise eliminator) 3, a count unit 4, and a feature quantity computation unit 5.

The input unit 2 is used for inputting reviews including comments for songs themselves to the device 1. The reviews are written by music writers, music companies, individuals (e.g., music critics) or the like having listened to or appreciated a relevant song: the reviews are to be registered with a song database. The input unit 2 inputs data of the reviews obtained via the Internet or from storage media storing the data of reviews. Here, when several reviews are available for a single song, combined review data is generated by combining the several reviews and is inputted from the input unit 2. Here, in the combined review data, a mark (hereinafter referred to as a respective-review terminating mark) is assigned to each connecting border between the several reviews combined so as to determine each connecting border.

The noise eliminator 3 eliminates, as noise, descriptions of inputted review data not related to the feature of a song itself. For instance, a song title (or a name of a song) included in review data is eliminated: the song title may frequently appear in the review data, but may not always indicate the feature or mood of the song.

The noise eliminator 3 extracts a word indicating a secondary song (i.e., so-called B-sided) other than a primary song (i.e., so-called A-sided) that is to be registered with the song database. The noise eliminator 3 then eliminates, as noise, the extracted word and its subsequent sentence. Each song CD commercially available may include several songs (a primary song and secondary song(s)): the review for the song CD may include those for secondary songs other than the primary song. In extracting a word (e.g., B-sided, second, C/W, coupling) indicating the secondary songs, the extracted word and sentences following the extracted word are eliminated as review parts of the secondary songs other than the primary song.

Further, as explained above, combined review data for the primary song may be also inputted. The noise eliminator 3 can be therefore differently designed to eliminate (i) a single sentence alone from the extracted word inclusive, (ii) sentences up to a next respective-review terminating mark from the extracted word inclusive, or (iii) sentences up to the end of the paragraph from the extracted word inclusive, instead of eliminating all the sentences from the extracted word inclusive.

The noise eliminator 3 generates review amendment data where parts regarded as noise are eliminated from the review data and then sends the generated review amendment data to the count unit 4. Thus, accuracy in a song feature quantity to be explained later can be enhanced.

The count unit 4, as a feature phrase appearances count unit, computes (e.g., increments or decrements) an appearances count of each of several feature phrase groups in the review amendment data from the noise eliminator 3. Here, “an appearances count” of a certain item means how frequent or how many times the certain item appears, and can be replaced with “a frequency count.” Each feature phrase group is predetermined to include a combination of several words for exhibiting a feature of a song.

How to determine a feature phrase group will be explained below. An operator analyses existing reviews and manually extracts feature phases exhibiting features of songs. For instance, as shown in FIG. 2, the feature phrase includes “tears . . . flowing,” “singing softly,” “voice heals,” “feel positive,” “words . . . cool,” or the like, but does not include a word or a phrase that is generally used for any type of songs such as “beautiful words” or “good melody.”

Further, a feature phrase is divided into a main word, and an attribute word pertinent to the main word. Here, a word group is defined to include, in addition to the main or attribute word, a word having a substantially similar meaning or a form-changed word (e.g., verb conjugation, capitalized).

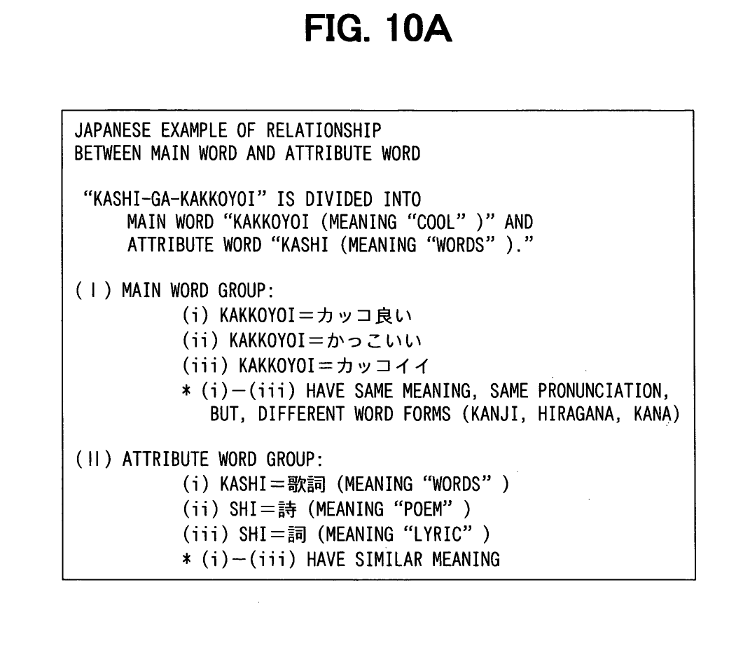

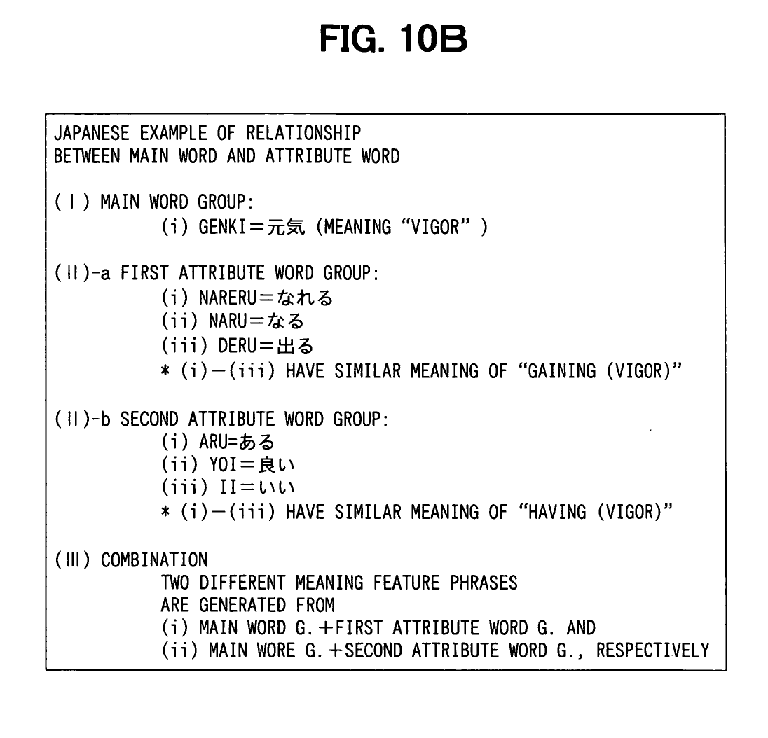

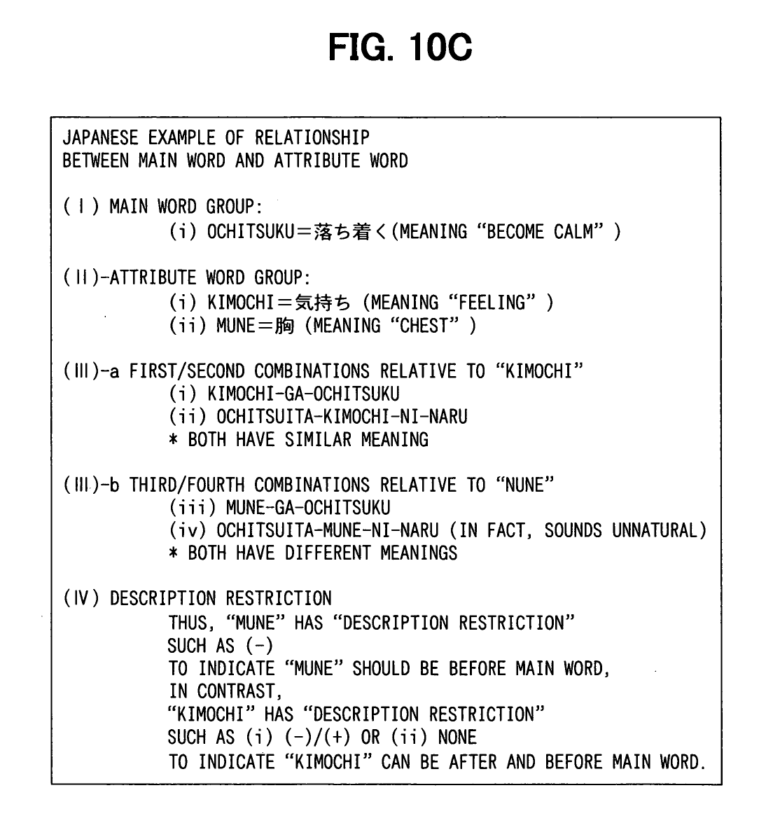

For instance, “words are cool” is divided into “cool” as the main word and “words” as the attribute word. Here, a main word group includes “cool,” “COOL,” “stunning,” “super” etc.; an attribute word group includes “words,” “poem,” “lyric,” etc. Yet, furthermore, for instance, “middle tempo,” “mid-tempo,” and “midtempo” are included in a single feature phrase group. (Corresponding Japanese examples are shown in FIG. 10A.)

Both of (i) the individual words in the main word group and (ii) the individual words in the attribute word group are variously combined to generate a feature phrase group, which is a group of phrases that have a substantially similar meaning. The song review data are estimated using feature phrase groups to compute a song feature quantity. This provides an effect to eliminate foreign information other than that related to a target song itself. For instance, suppose that “singer's face is cool” not related to a target song is included in the review data. Its meaning is very different from a feature phrase “words are cool,” thereby resulting in disregard as noise in computing the song feature quantity of the target song.

Further, when a certain main word group is combined with different attribute word groups, different feature phrases may be generated. For instance, a main word group “good” is combined with a first attribute word group “look” or “seem” to generate a first feature phrase group: the main word group “good” is combined with a second attribute word group “getting” or “becoming” to generate a second feature phrase group that is different from the first feature phrase group. (Corresponding Japanese examples are shown in FIG. 10B.)

Further, an appearance order of the main word and the attribute word can be defined depending on each word. For instance, the main word “alive” is always preceded by the attribute word. “Words are alive” is a natural expression, whereas “alive words” are not natural. In contrast, “words are sweet” and “sweet words” have a similar meaning. Therefore, “alive” should have a description restriction such as (+) indicating that the main word “alive” should be preceded by the attribute word group. For instance, “sweet” should have both (+) (−) or none of them. (Corresponding Japanese examples are shown in FIG. 10C.)

The count unit 4 computes with respect to each feature phrase group an appearances count in the review amendment data. This will be explained below in detail. The count unit 4 subjects the review amendment data sent from the noise eliminator 3 to a morphological analysis. An appearances count is incremented when two following conditions are satisfied: A first condition is that a single sentence includes (i) a main word in a main word group of a feature phrase group and (ii) an attribute word in an attribute word group of the feature phrase group; a second condition is that the single sentence includes no negative word such as “not,” “no,” “hardly,” or “seldom.” (It is because the negative word reverses a meaning of the sentence.) A negative word may be located anywhere in a sentence, e.g., just after or just before the main word, or at the end of a sentence. The negative word includes a word negating the meaning of a feature phrase or a word indicating that the meaning of the feature phrase is scarce. Further, as explained above, when the main word or the attribute word has a description restriction relating to an appearance order, complying with the description restriction can be another condition. This prevents an appearances count from being incremented when the main word and the attribute word included in a single feature phrase group are arranged meaninglessly without following the description restriction.

Further, when a negative word is included in a sentence including a certain feature phrase group, the appearances count relative to the certain feature phrase group may be decremented: the feature phrase having the negative word may indicates a contrary meaning.

Thus, the count unit 4 computes an appearances count relative to each feature phrase group to output a resultant count to the feature quantity computation unit 5. The unit 5, as a song feature quantity computation unit, computes a song feature quantity of a vector quantity based on the resultant count acquired.

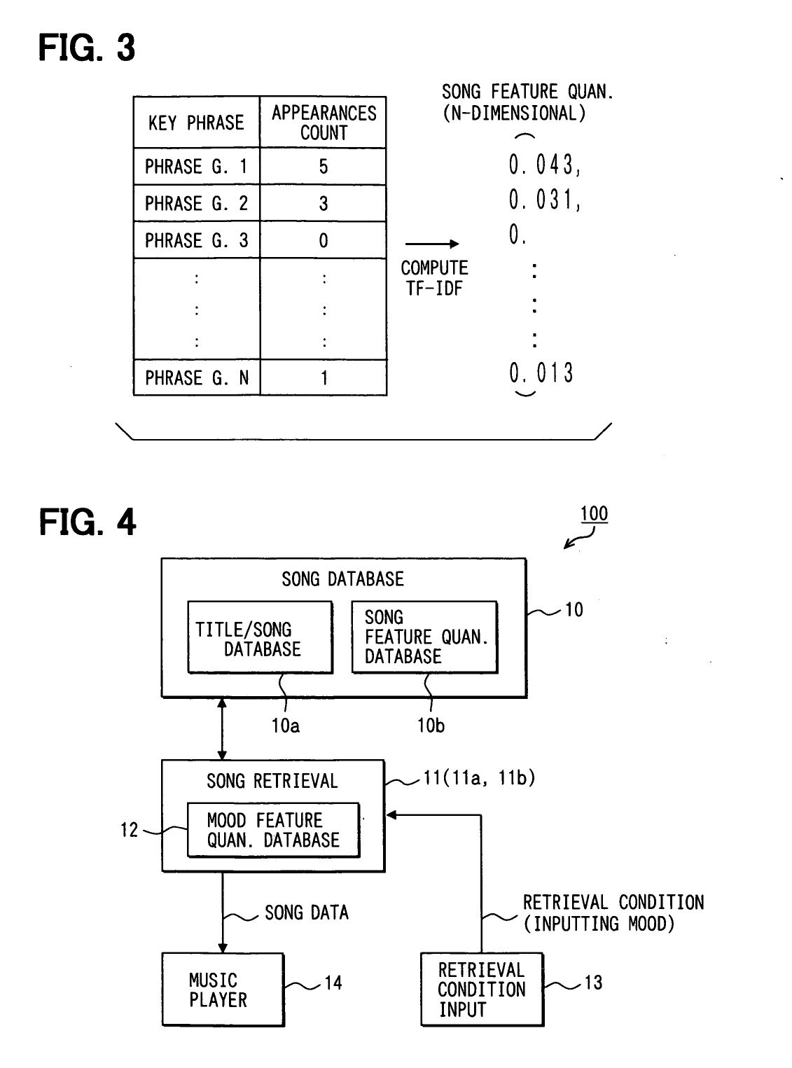

A computation method of a song feature quantity will be explained with reference to FIG. 3. When acquiring the appearances count for each feature phrase group (in FIG. 3), the feature quantity computation unit 5 computes a known TF-IDF (Term Frequency/Inverse Document Frequency) value as a computation value variable depending on appearances counts. An example of a TF-IDF value will be explained below.

At first, the number of songs targeted for computing a song feature quantity is defined as U. Here, with respect to each targeted song, its data should be retrieved (e.g., registered with the song database), and at least one review of it should be available. Under definitions of a song j (j=1 to U), its review data item j, and its related feature phrase group i (i=0 to N), TFT-IDF value W(ij) is obtained from Formula 1 as follows:
W(ij)=ff(ij)×log(U/df(i)) Formula 1

Here, tf(ij) is an appearances count of a feature phase group i in the review data item j: df(i) is the number of review data items that include the feature phrase group i in all songs' review data items. Thus, the TF-IDF value considers the number of the review data items that include the feature phrase group i, in addition to the appearances count of the feature phrase group i in the review data item j. The TF-IDF value thereby reflects relative importance of each feature phrase group. In computing the TF-IDF value of each feature phrase group, the feature quantity computation unit 5 generates a vector constituted by constituents (i.e., elements) of the TF-IDF value as a song feature quantity. That is, the number of the feature phrase groups accords with the dimension of the vector.

As explained above, the song feature quantity computation device 1 according to the embodiment performs as follows: Predetermining several feature phrase groups, each of which includes a combination of a main word and an attribute word; computing an appearances count of each feature phrase group in each review data item; computing a song feature quantity of a vector quantity constituted by elements being values computed based on the appearances counts of the feature phrase groups; regarding the computed song feature quantity as an index indicating a feature of the relevant song.

Thus, applying feature phrase groups allows simple computation of appearances counts to indicate a feature of a relevant song with a high accuracy. In other words, use of each feature phrase group functions to filter comments not related to the feature of each song. This allows the song feature quantity, computed based on the appearances counts of the feature phrase groups, to accurately match with a mood of the relevant song having been listened to.

Next, a song retrieval system 100 will be explained below with references to FIGS. 4 to 6. The song retrieval system 100 is to retrieve a preferred song from the song database including song feature quantities computed by the above-described song feature quantity computation device 1. As shown in FIG. 4, the system 100 includes the following: a song database 10, a song retrieval unit 11, a music player 14 as a song playing unit, and a retrieval condition input unit 13.

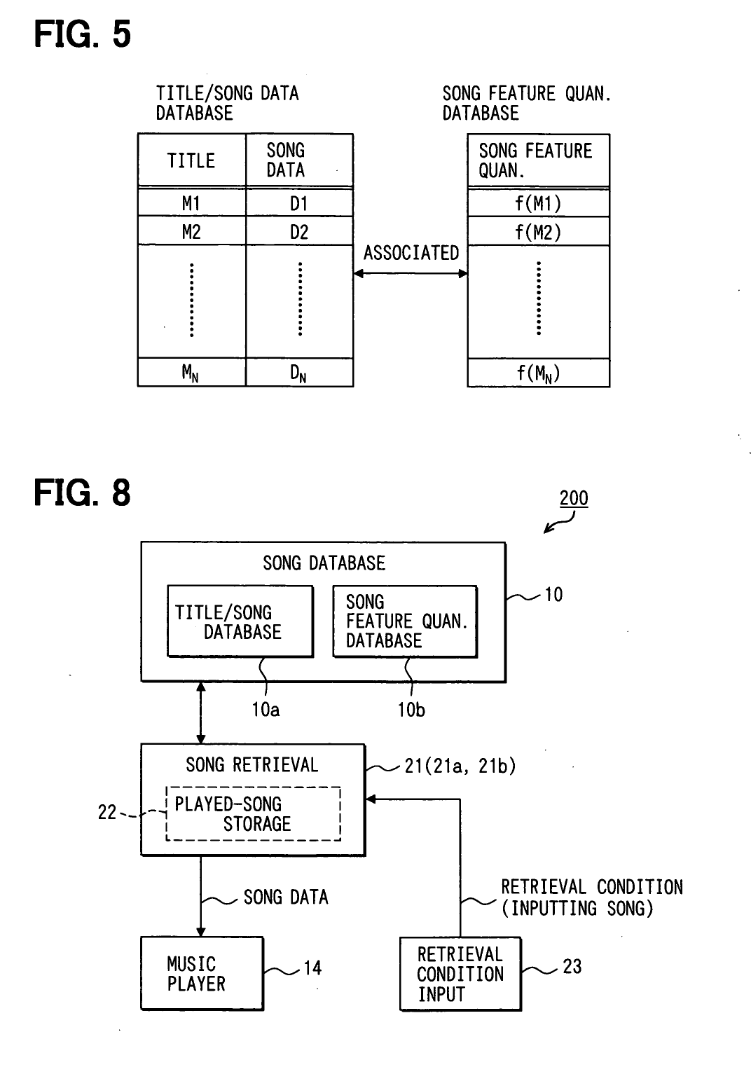

The song database 10 includes a title/song database unit 10a and a song feature quantity database unit 10b. An example of the database 10 is shown in FIG. 5: title data, song data (e.g., MP3 data), and song feature quantity data are stored and associated with each other. The three types of data are associated by having in common an ID number (unique to each song).

Here, the database 10 is divided into two database units 10a, 10b based on the following reason: a new song is released on a daily basis even after the database 10 is formed, so that data related to the new song is assumed to be added into the database 10; and at this time, a feature quantity of a previously stored song may be required to be updated in the database 10. As explained above, the TF-IDF value is computed using (i) the total number U of all the songs, and (ii) the number of the review data including a feature phrase group i, and thereby is variable when the new data is added. The song feature database unit 10b is therefore formed separately from the other unit 10a in the database 10 to be entirely updated based on the additional registry of each new song data item.

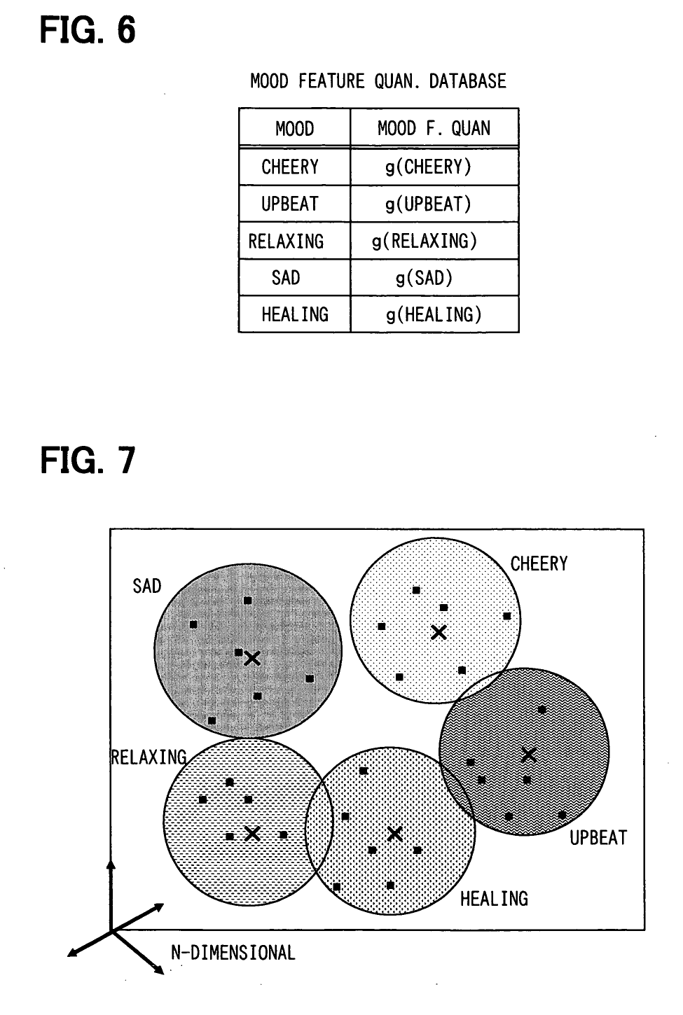

The retrieval condition input unit 13, as a retrieval specifying unit, inputs any one of several predetermined moods (musical moods, musical atmosphere) as a retrieval condition for selecting a preferred song of a user. These moods are represented by a symbol C, hereinafter in the first embodiment. The moods are defined with mood expressional words, e.g., “cheery,” “upbeat,” “relaxing,” “sad,” and “healing” shown in FIG. 6. The song retrieval unit 11 retrieves from the song database 10 a song matching with the inputted mood based on a mood feature quantity g(C) relative to each song stored in a mood feature quantity database 12.

Here, a setting method of the mood feature quantity g(C) relative to each song will be explained below. Several songs are selected from tens or hundreds of songs as learning data. The number of learning data items is represented by P: each song for the learning data is represented by Tj (j=1, . . . , P). Several test subject persons or examinees listen to each song Tj and thereby select its corresponding moods; for instance, the most frequently selected mood is consequently selected as a single mood of each song. Thus, the learning data item Tj belonging to each mood is determined. Each mood is selected to belong to at least one learning data item Tj.

With respect to each mood C, a template is generated from a song feature quantity of a song that each mood belongs to. For instance, a template is generated by averaging the song feature quantities of the songs belonging to each mood. Suppose that a mood is “cheery” and the songs belonging to “cheery” are T1, T2, T4, and T7. The mood feature quantity g(C) is computed on Formula 2 below:
g(cheery)=(f(T1)+f(T2)+f(T4)+f(T7))/4 Formula 2

The mood feature quantity g(C) is thus obtained as the average of the song feature quantities of the several songs belonging to each mood. The song retrieval unit 11 then determined which mood each song stored in the song database 10 belongs to. For instance, the mood a certain song belongs to is determined by selecting the smallest vector distance among vector distances from the feature quantity of the certain song to each mood quantity g(C). An example of a range of a song feature quantity is shown in FIG. 7. A song feature quantity representing a mood is thus fixed as a template, thereby determining which mood each song stored in the song database 10 belongs to.

The above-described vector distance can be the Euclid distance, the City-block distance, the Mahalanobis distance, etc. Alternatively, a feature quantity can be also assigned to each mood as a mood feature quantity to be stored in a mood feature quantity database 12.

The music player 14, receiving the data item of the song retrieved by the song retrieval unit 11, plays or reproduces the received data item. When several songs are retrieved, the player 14 determines a playing order for them as needed.

As explained above, according to the song retrieval system 100 of the first embodiment, the following is performed: A mood feature quantity relative to a mood represented by a mood expressional word is previously stored; when a mood is specified as a song retrieval condition, a song belonging to the specified mood can be retrieved with a high accuracy based on the mood feature quantity of the specified mood and the feature quantity of each song.

### Second Embodiment

A second embodiment will be explained with reference to FIG. 8. In the second embodiment, a preferred song of a user is retrieved also from the song database 10 including song feature quantities computed by the song feature quantity computation device 1 according to the first embodiment. The second embodiment is different from the first embodiment in that a preferred song is retrieved using a retrieval condition different from that of the first embodiment. Therefore, only a song retrieval system 200 according to the second embodiment will be explained below. The same components as those of the first embodiment are assigned the same reference numbers and their explanation will be basically eliminated below.

As shown in FIG. 8, the system 200 includes the following: a song database 10, a song retrieval unit 21, a music player 14 as a song playing unit, and a retrieval condition input unit 23.

The retrieval condition input unit 23, as a retrieval specifying unit, specifies a single song stored in the song database 10 as a song retrieval condition. The song retrieval unit 21 retrieves the specified song and a similar song that is similar to the specified song, and plays or reproduces these retrieved songs. Thus, a user can listen to not only the specified song but also the song similar to the specified music by specifying only the single preferred song.

A retrieval method of a similar song will be explained below. The retrieval method is executed by the song retrieval unit 21. In the song database 10, each song in the title/song database unit 10a is associated with the song feature quantity, which is computed by the song feature quantity computation device 1 according to the first embodiment and stored in the song feature quantity database unit 10b. The song feature quantity is the vector value constituted by elements being TF-IDF values computed based on the appearances counts of the feature phrase groups in the review data: a similarity degree of another song relative to a certain song can be determined using a vector distance computed from the respective song feature quantities. Thus, specifying the certain song from the song database 10 enables a similar song to be retrieved with a high accuracy based on the respective song feature quantities.

For instance, when a song Mi is specified as a retrieval condition, the song retrieval unit 21 computes a vector distance between (i) a song feature quantity f(Mi) and (ii) a song feature quantity f(Mj) of another song Mj (j≠i) stored in the song database 10. The unit 21 then retrieves another song Mj corresponding to the vector distance less than a threshold value H, shown in Formula 3.
d(f(Mi), f(Mj))≦H Formula 3

Here, a given song's vector distance that is less than the threshold value H is determined to be a similar song: the given song to be retrieved may be multiple or none (or zero), not limited to one.

To retrieve at least one song, the similar song should be differently defined to have the minimum vector distance from that of the specified song. This allows the song retrieval unit 21 to retrieve a single song as the similar song from the song database 10; however, this does not allow the song retrieval unit 21 to retrieve several songs as a similar song. To deal with this, an additional similar song should be retrieved by regarding the above retrieved and played similar song as a newly specified song. Here, the once played song should not be re-played; therefore, a played-song storage unit 22 may be provided for storing songs having been already played. When retrieving a similar song, the song retrieval unit 21 prevents the already played song from being played twice, with reference to the played-song storage unit 22.

### Third Embodiment

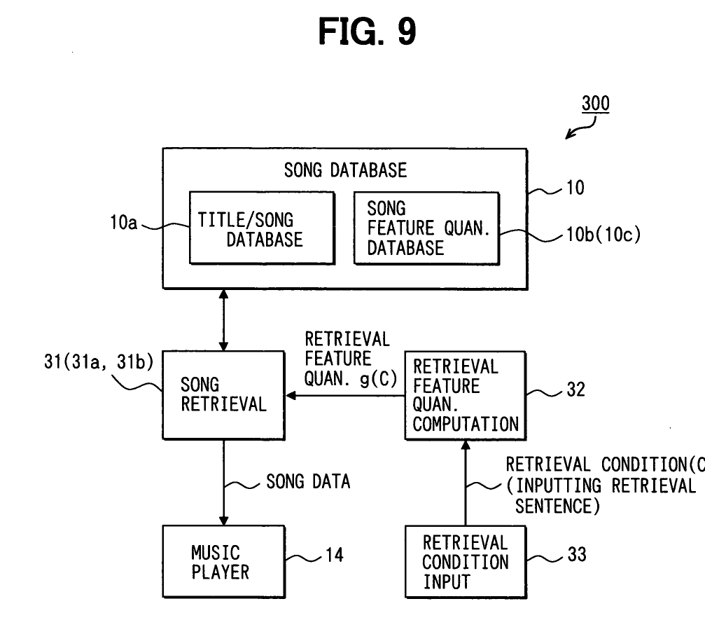

A third embodiment will be explained with reference to FIG. 9. In the third embodiment, a preferred song of a user is retrieved also from the song database 10 including song feature quantities computed by the song feature quantity computation device 1 according to the first embodiment. The third embodiment is different from the first and second embodiments in that a preferred song is retrieved using a retrieval condition different from those of the first and second embodiments. Therefore, only a song retrieval system 300 according to the third embodiment will be explained below. The same components as those of the first embodiment are assigned the same reference numbers and their explanation will be basically eliminated below.

As shown in FIG. 9, the system 300 includes the following: a song database 10, a song retrieval unit 31, a retrieval feature quantity computation unit 32, a music player 14 as a song playing unit, and a retrieval condition input unit 33.

The retrieval condition input unit 33, as a retrieval specifying unit, uses as a song retrieval condition a sentence (e.g., “a song is relaxing and healing”) indicating a feature of a song; further, the unit 33 includes a keyboard or a voice recognition unit for a user to input a preferred sentence (or retrieval sentence). This sentence indicating a feature of a song is represented by a symbol C, hereinafter in the third embodiment. The retrieval feature quantity computation unit 32 analyses the inputted retrieval sentence and generates a retrieval feature quantity g(C).

Next, a process for generating the retrieval feature quantity g(C) in the retrieval feature quantity computation unit 32 will be explained below. The retrieval feature quantity computation unit 32 subjects the inputted retrieval sentence to a morphological analysis to extract a self-sufficient word and a negative word (e.g., “not,” “no,” “hardly”). With respect to the extracted self-sufficient word, at least one of similar meaning word, resembling meaning word, and antonym is acquired using a linguistic database such as a thesaurus dictionary: a similar meaning word has a meaning similar to that of the extracted self-sufficient word, a resembling meaning word has a meaning resembling to that of the extracted self-sufficient word, and an antonym has a meaning opposite to that of the extracted self-sufficient word. (Here, a predetermining unit 10c may be additionally provided for instance in the song feature quantity database 10b. Both of the similar meaning word and resembling meaning word can be referred to as a synonym.) The self-sufficient word and at least one of the similar meaning word, resembling meaning word, and antonym are designated as retrieval words. Then, it is determined whether the retrieval words are included in the main word groups or the attribute word groups, which are described in the first embodiment. When determined that the retrieval words are included, it is then determined whether the retrieval words are accompanied by a negative word. The appearances counts of the word groups are computed in the positive or negative direction (i.e., incremented or decremented) depending on the determination results. Using the retrieval words thus including at least one of the similar meaning word, resembling meaning word, and antonym in addition to the self-sufficient word allows the retrieval feature quantity g(C) indicating a feature of the retrieval sentence to be computed with a high accuracy. Here, the retrieval feature quantity computation unit 32 further functions as a word appearances count unit.

The retrieval words may be accompanied by no negative word; therefore, the appearances counts of the word group in the retrieval sentence may be incremented (in the positive direction). In this case, an appearances count of the self-sufficient word is incremented by “1,” whereas, that of the similar meaning word and/or resembling meaning word is incremented by predetermined “i” or “j” (0<i≦1, 0<j≦1), respectively. That is, with respect to the similar meaning word or resembling meaning word, its appearances count can be incremented by “1” or “less than 1 and more than 0”: the similar meaning word or the resembling meaning word is not exactly the same as the self-sufficient word itself. Similarly, with respect to the antonym, its appearances count k can be incremented by predetermined “k” (−1≦k<0).

Furthermore, depending on a type of a negative word (e.g., “no”), when this negative word appears just before the retrieval word, the above count values (1, i, j, k) may be multiplied by “−1” and then an appearances count of a word group in the retrieval sentence are computed: the presence of the negative word appearing just before the retrieval word indicates the opposite meaning against the retrieval word. (In a Japanese example, when a negative word appears just after the retrieval word, the above count values (1, i, j, k) is multiplied by “−1” and then the appearances count of the word group in the retrieval sentence are computed: the presence of the negative word just after the retrieval word indicates the opposite meaning against the retrieval word.)

As explained above, a self-sufficient word included in a retrieval sentence is determined whether to correspond to a retrieval word. Then, the self-sufficient word corresponding to a retrieval word is subjected to a computing process of its appearances count. Thereby, the appearances counts of word groups included in the main word group or the attribute word group can be computed. The retrieval feature quantity computation unit 32 regards the appearances count of each word group as an appearances count of a feature phrase group including the each word group, and computes a retrieval feature quantity g(C) of a vector quantity constituted by the each appearances count. This enables computation of a vector distance between the retrieval feature quantity g(C) and a song feature quantity f(Mi) of each song. The vector distance can be an index indicating a similarity degree between the retrieval word and the feature of the each song: based on the vector distance, the song having the feature corresponding to the retrieval sentence can be retrieved.

In the above embodiment, the retrieval sentence is estimated not using feature phrase groups but using the main word group and the attribute word group; therefore, for instance, even when a retrieval sentence only having a single word “cheery” is inputted, a song corresponding to this retrieval sentence can be retrieved.

(Modification)

In the above, the preferred embodiments of the present invention are explained; however, the present invention can be modified without limited to the above embodiments as far as within the scope of the present invention.

For instance, the song retrieval systems 100, 200, 300 can be so provided that the retrieval condition input unit 13, 23, 33 and the music player 14 are located in a client and the other components (e.g., the song database 10, the song retrieval unit 11, 21, 31) are in a song distribution center that communicates with the client. Providing the song distribution center with the song database 10 allows a new song to be rapidly added. This configuration of the system may make it difficult for a user as a client to completely know which song is registered with the song database 10; however, using the above-described individual song retrieval systems 100, 200, 300 enables a retrieval of a preferred song with a high accuracy.

Furthermore, the song retrieval unit 11, 21, 31 can include a storage unit 11a, 21a, 31a (as a specified mood storage unit, a specified song storage unit, or a specified retrieval storage unit) to store specifications (i.e., a specified mood, specified song, or specified retrieval sentence) that are related to a retrieval condition and inputted from the retrieval condition input unit 11, 21, 31. Furthermore, the song retrieval unit 11, 21, 31 can include a recommended song presenting unit 11b, 21b, 31b to present to a user a recommend song matching with a user's taste based on the stored results in the storage unit. For instance, when a specific mood is specified in many times as a retrieval condition, a certain song belonging to the specific mood is assumed to be matching with the user's taste based on the stored results: Recommending the certain song to the user allows the user to increase a chance to listen to a song matching with user's taste.

Here, the recommend song presenting unit may select a feature phrase indicating a feature of the recommend song, and then may present a sentence for recommendation based on the feature quantity of the song presented as a recommended song. As explained above, the song feature quantity is computed as a vector quantity having as elements the TF-IDF values computed based on the appearances count of each feature phrase in the review data: based on the TF-IDF values, the feature phrase group characterizing the corresponding songs can be selected.

Specifically, the following process can take place: defining a recommended song as Mi, and its feature quantity as f(Mi); selecting, from the feature quantity f(Mi), vector elements having values exceeding a threshold, wherein the selected vector elements correspond to phrase groups properly indicating the feature of the song Mi; and combining the phrase groups to form a sentence for recommendation. For instance, suppose that two vector elements in the song feature quantity f(Mi) are selected, and a first element is “singing softly” and a second is “voice is healing.” In this case, a sentence for recommendation becomes “sweet singing voice is healing,” which allows a user to accurately understand what kind of song the song retrieval system recommends and why the system recommends the song Mi. The user can thereby easily accept the recommendation. In particular, in a case that the above song distribution center runs a paid song distribution service and recommends a song yet to be sold to the user, the above system can have an effect to prompt a user to purchase a license for the song.

Furthermore, in the above embodiments, the TF-IDF values are used for vector elements; however, the appearances counts of phrase groups can be simply used for the vector elements.

Furthermore, the song database 10 stores song data for playing each song; however, the database 10 can alternatively store index data indicating an access point to retrieve the relevant song instead of the song data item itself.

It will be obvious to those skilled in the art that various changes may be made in the above-described embodiments of the present invention. However, the scope of the present invention should be determined by the following claims.

What is claimed is:

1. A song feature quantity computation device for computing a song feature quantity that is associated with a song of a plurality of songs and stored in a song database, the device comprising:
an input unit for inputting a review data item including a review of the song;
a feature phrase appearances count unit for computing, as an index indicating a feature of the song, a feature phrase appearances count of each of a plurality of feature phrases in the inputted review data item, wherein each feature phrase is predetermined to include a combination of words; and
a song feature quantity computation unit for computing values depending on the feature phrase appearances counts of the plurality of feature phrases, respectively, and computing a song feature quantity being a vector quantity constituted by the computed values as elements.

2. The song feature quantity computation device of claim 1, wherein,
the song feature quantity computation computes the values by considering a number of review data items including each feature phrase in all the review data items included in the song database.

3. The song feature quantity computation device of claim 1, wherein,
the feature phrase appearances count unit excludes a music title of the song from a target for counting the feature phrase appearances count when computing the feature phrase appearances count of the each of the plurality of feature phrases.

4. The song feature quantity computation device of claim 1, wherein,
the feature phrase appearances count unit
extracts a certain word indicating a certain song other than a primary song when a certain comment related to the certain song is included in the review data item, and
excludes the certain word and a sentence preceded by the certain word from a target for computing the feature phrase appearances count of the each of the plurality of feature phrases.

5. The song feature quantity computation device of claim 1, wherein,
the feature phrase appearances count unit
subjects the inputted review data item to a morphological analysis to determine whether words constituting a single feature phrase is included in a single sentence, and
computes the feature phrase appearances count of the single feature phrase when the words constituting the single feature phrase is determined to be included in the single sentence.

6. The song feature quantity computation device of claim 5, wherein,
each of the words constituting the single feature phase is replaceable, in constituting the single feature phrase, with a word group that includes the each of the words and a word having a meaning similar or resembling to the each of the words.

7. The song feature quantity computation device of claim 5, wherein,
the words constituting the single feature phase have predetermined order between the words in the single feature phase, and
the feature phrase appearances count of the single feature phrase is computed only when the words appear in the predetermined order.

8. The song feature quantity computation device of claim 5, wherein,
when the single sentence including the words constituting the single feature phase is determined to further include no negative word, the feature phrase appearances count of the single feature phrase is incremented.

9. The song feature quantity computation device of claim 8, wherein,
when the single sentence is determined to further include a negative word, the feature phrase appearances count is decremented.

10. A song retrieval system for retrieving a song from the song database including song feature quantities computed by the song feature quantity computation device of claim 1, the system comprising:
a first retrieval specifying unit for specifying, as a song retrieval condition, a musical mood of a plurality of musical moods, wherein each of the musical moods is indicated by a mood expressional word;
a corresponding range storage unit for storing a predetermined corresponding range of a song feature quantity relative to the specified musical mood; and
a first retrieval unit for retrieving from the song database a song including a song feature quantity belonging to the specified musical mood, based on the corresponding range relative to the specified musical mood.

11. The song retrieval system of claim 10, wherein
the corresponding range storage unit stores a representative song feature quantity relative to the musical mood as the predetermined corresponding range, and
the first retrieval unit retrieves from the song database a certain song including a certain song feature quantity, when a vector distance between the representative song feature quantity relative to the specified musical mood and the certain song feature quantity is less than a vector distance between a representative song feature quantity relative to another musical mood other than the specified musical mood and the certain song feature quantity.

12. The song retrieval system of claim 10, wherein
the song database, the corresponding range storage unit, and the first retrieval unit are provided in a song distribution center, while the first retrieval specifying unit is provided in a client, and
the song distribution center and the client communicate with each other.

13. The song retrieval system of claim 10, further comprising:
a specified mood storage unit for storing the specified musical mood; and
a first recommended song presenting unit for presenting a recommended song matching with a user's taste assumed based on results stored in the specified mood storage unit.

14. The song retrieval system of claim 13, wherein
the first recommended song presenting unit selects, based on a feature phrase quantity of a song presented as the recommended song, a certain feature phrase indicating a feature of the recommended song, and presents a sentence for recommendation using the certain feature phrase.

15. A song retrieval system for retrieving a song from the song database including song feature quantities computed by the song feature quantity computation device of claim 1, the system comprising:
a second retrieval specifying unit for specifying as a song retrieval condition a song stored in the song database and requiring a retrieval of a similar song that is similar to the specified song; and
a second retrieval unit for retrieving the similar song, by defining the similar song and extracting the similar song from retrieval target songs that are the songs stored in the song database, based on a vector distance between (i) a song feature quantity of the specified song and (ii) each of song feature quantities of the retrieval target songs.

16. The song retrieval system of claim 15, wherein
the second retrieval unit extracts a similar song from the retrieval target songs by defining as the similar song a certain song, a vector distance between (i) the song feature quantity of the specified song and (ii) a song feature quantity of the certain song is a predetermined threshold or less.

17. The song retrieval system of claim 15, wherein
the second retrieval unit extracts a similar song from the retrieval target songs by defining as the similar song a certain song, a vector distance between (i) the song feature quantity of the specified song and (ii) a song feature quantity of the certain song is less than a vector distance between (i) the song feature quantity of the specified song and (ii) a song feature quantity of another song included in the retrieval target songs.

18. The song retrieval system of claim 17, further comprising:
a song playing unit for playing a song retrieved by the second retrieval unit, wherein
the second retrieval unit
defines as the specified song a song that is played by the song playing unit, and
extracts a given song from not-played songs, which have been not played by the song playing unit and in the song database, a vector distance between (i) a song feature quantity of the defined song and (ii) a song feature quantity of the given song is less than a vector distance between (i) the song feature quantity of the defined song and (ii) a song feature quantity of another song included in the not-played songs, and
the song playing unit sequentially plays a plurality of songs that are sequentially retrieved by the second retrieval unit.

19. The song retrieval system of claim 15, wherein
the song database, and the second retrieval unit are provided in a song distribution center, while the second retrieval specifying unit is provided in a client, and
the song distribution center and the client communicate with each other.

20. The song retrieval system of claim 15, further comprising:
a specified song storage unit for storing the specified song; and
a second recommended song presenting unit for presenting a recommended song matching with a user's taste assumed based on results stored in the specified song storage unit.

21. The song retrieval system of claim 20, wherein
the second recommended song presenting unit selects, based on a feature phrase quantity of a song presented as the recommended song, a certain feature phrase indicating a feature of the recommended song, and presents a sentence for recommendation using the certain feature phrase.

22. A song retrieval system for retrieving a song from the song database including song feature quantities computed by the song feature quantity computation device of claim 1, the system comprising:
a third retrieval specifying unit for specifying, as a song retrieval condition, a retrieval sentence representing a feature of a song;
a word count unit for
determining whether a retrieval word corresponding to a word in a feature phrase is included in the specified retrieval sentence, and
computing a word appearances count indicating how many times the retrieval word, which is determined to be included in the specified retrieval sentence, appears in the specified retrieval sentence;
a retrieval feature quantity computation unit for
computing a retrieval feature quantity being a vector quantity constituted by feature phrase appearances counts of the feature phrases by regarding the computed word appearances count of the retrieval word as a feature phrase appearances count of each of the feature phrases that includes the retrieval word; and
a third retrieval unit for retrieving a certain song having a song feature quantity similar to the computed retrieval feature quantity, by defining the certain song from retrieval target songs that are the songs stored in the song database, based on a vector distance between (i) the computed retrieval feature quantity and (ii) each of song feature quantities of the retrieval target songs.

23. The song retrieval system of claim 22, further comprising:
a predetermining unit for predetermining, with respect to a certain word in a feature phrase, at least one word of a similar meaning word, a resembling meaning word, and an antonym, wherein
the word count unit regards the certain word and the at least one word as the retrieval word, and then computes a word appearances count indicating how many times the retrieval word appears in the specified retrieval sentence.

24. The song retrieval system of claim 23, wherein
the predetermining unit predetermines varied values i, j by which the word count unit varies a word appearances count when each of the similar meaning word and the resembling meaning word appears, respectively, and
each of the values i, j is more than 0 and not more than 1 (0<i, j≦1).

25. The song retrieval system of claim 23, wherein
the predetermining unit predetermines a varied value k by which the word count unit varies a word appearances count when the antonym appears, and
the value k is not less than −1 and less than zero (−1≦k<0).

26. The song retrieval system of claim 23, wherein
when a negative word precedes, in the specified retrieval sentence, a retrieval word including any one of (i) the certain word, (ii) the similar meaning word, and (iii) the resembling meaning word, the word count unit decrements a word appearances count relative to the certain word.

27. The song retrieval system of claim 23, wherein
when a negative word precedes, in the specified retrieval sentence, a retrieval word including the antonym, the word count unit increments a word appearances count relative to the certain word.

28. The song retrieval system of claim 22, wherein
the song database, the word count unit, the retrieval feature quantity computation unit, and the third retrieval unit are provided in a song distribution center, while the third retrieval specifying unit is provided in a client, and
the song distribution center and the client communicate with each other.

29. The song retrieval system of claim 22, further comprising:
a specified retrieval sentence storage unit for storing the specified retrieval sentence; and
a third recommended song presenting unit for presenting a recommended song matching with a user's taste assumed based on results stored in the specified retrieval sentence storage unit.

30. The song retrieval system of claim 29, wherein
the third recommended song presenting unit selects, based on a feature phrase quantity of a song presented as the recommended song, a certain feature phrase indicating a feature of the recommended song, and presents a sentence for recommendation using the certain feature phrase.

31. The song retrieval system of claim 23, wherein:
the song retrieval system is used in a Japanese language situation; and
when a negative word follows, in the specified retrieval sentence, just after a retrieval word including any one of (i) the certain word, (ii) the similar meaning word, and (iii) the resembling meaning word, the word count unit decrements a word appearances count relative to the certain word.

32. The song retrieval system of claim 23, wherein:
the song retrieval system is used in a Japanese language situation; and
when a negative word follows just after a retrieval word including the antonym, the word count unit increments a word appearances count relative to the certain word.
